(19) United States
(12) Patent Application Publication
(10) Pub. No.: US 2009/0317311 A1
(43) Pub. Date: Dec. 24, 2009

(54) DISPENSER CONTROL SYSTEMS AND METHODS

(75) Inventors: Andrew J. Cocking, Ben Lomond, CA (US); Michael A. Steed, Santa Cruz, CA (US); Erik Miller, Scotts Valley, CA (US)

Correspondence Address: JohnsonDiversey, Inc., 8310 16TH STREET, M/S 509, PO BOX 902, STURTEVANT, WI, 53177-0902, US

(73) Assignee: JOHNSONDIVERSEY, INC., Sturtevant, WI (US)

(21) Appl. No.: 12/524,052

(22) PCT Filed: Jan. 31, 2008
(86) PCT No.: PCT/US08/52672

§ 371 Date: Jul. 22, 2009

Related U.S. Application Data
(60) Provisional application No. 60/887,681, filed on Feb. 1, 2007.
(60) Provisional application No. 60/939,142, filed on May 21, 2007.

(51) Int. Cl. B01D 11/02

(52) U.S. Cl. 422/261

(57) ABSTRACT

A method of operating a dispensing system having a material delivery cycle. In some embodiments, the material delivery cycle includes supplying water to a receptacle, performing an operation intended to release a material into the water, and delivering the material to a downstream component. The first step of the method is to initiate the material delivery cycle. Next, a conductivity proximate to the receptacle is monitored. Additionally, one or more error conditions are identified during the material delivery cycle based at least partially on the monitored conductivity.

### BACKGROUND

The invention generally relates to material dispensing systems. More specifically, the invention relates to methods and systems of operating and controlling material dispensing systems.

As washing machines (e.g. dish washing machines, clothes washing machines, etc.) have become more sophisticated, systems have been implemented to automatically feed such machines with detergents, sanitizers, rinse aids, and the like, which may be produced in liquid, condensed, compressed, granulated, and/or powdered form. Such materials may be automatically delivered to a variety of types of washing machines.

### SUMMARY

In one embodiment, the invention includes a method of operating a dispensing system having a material delivery cycle. The material delivery cycle includes supplying water to a receptacle, performing an operation intended to release a material into the water, and delivering the material to a downstream component. The method includes initiating the material delivery cycle; monitoring a conductivity proximate to the receptacle; and identifying one or more error conditions during the material delivery cycle based at least partially on the monitored conductivity.

In another embodiment a dispensing system for delivering a material to a receiving component positioned downstream of the dispensing system includes a receptacle, a valve, a material metering device, a sensor, and a controller. The valve controls a supply of water to the receptacle and has an off position that prevents water from entering the receptacle and an on position that allows water to enter the receptacle. The material metering device dispenses a material into the receptacle. The sensor is positioned proximate to the receptacle and generates a first signal that is indicative of conductivity. The controller receives the first signal from the sensor and generates a valve control signal and a material metering device control signal. The valve control signal can toggle the valve between the on position and the off position. The material metering device control signal can to initiate a dispensing of the material. The valve control signal and the material metering device signal are generated at least partially in response to a comparison by the controller of the first signal to one or more stored conductivity threshold values.

In another embodiment, a method of operating a dispensing system includes initiating a material delivery cycle having a pre-flush period, a material dosing period, and a post-flush period. Next, a first conductivity during the pre-flush period is monitored and compared to one or more thresholds, where the comparison is used to determine whether to initiate a material delivery during the material dosing period. Next, a second conductivity is monitored during the dosing period and compared to the one or more thresholds, where the comparison is used to determine whether material has been dispensed during the material dosing period. Next, a third conductivity is monitored during a post-flush period and compared to the one or more thresholds, where the comparison is used to verify that the material delivered during the dosing period has been delivered to a receiving component positioned downstream of the dispensing system.

Other aspects of the invention will become apparent by consideration of the detailed description and accompanying drawings.

### BRIEF DESCRIPTION OF THE DRAWINGS

FIG. 1 illustrates an exemplary dispensing system, according to an embodiment of the invention.

FIG. 2 illustrates an exemplary embodiment of a dispensing closure, according to an embodiment of the invention.

FIG. 3 illustrates an exemplary dispensing system, according to another embodiment of the invention.

FIG. 4 illustrates an exemplary dispensing system, according to yet another embodiment of the invention.

FIG. 5 is a block diagram of an exemplary control system, according to an embodiment of the invention.

FIG. 6 illustrates an exemplary process for controlling operations of a dispensing system, according to an embodiment of the invention.

FIG. 7-19 illustrate exemplary plots that represent a sensed conductivity during a material delivery cycle, according to an embodiment of the invention.

FIG. 20 illustrates an exemplary embodiment of a condition indicator, according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As should also be apparent to one of ordinary skill in the art, the systems shown in the figures are models of what actual systems might be like. Many of the modules and logical structures described are capable of being implemented in software executed by a microprocessor or a similar device or of being implemented in hardware using a variety of components including, for example, application specific integrated circuits (“ASICs”). Terms like “controller” may include or refer to both hardware and/or software. Furthermore, throughout the specification capitalized terms are used. Such terms are used to conform to common practices and to help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware.

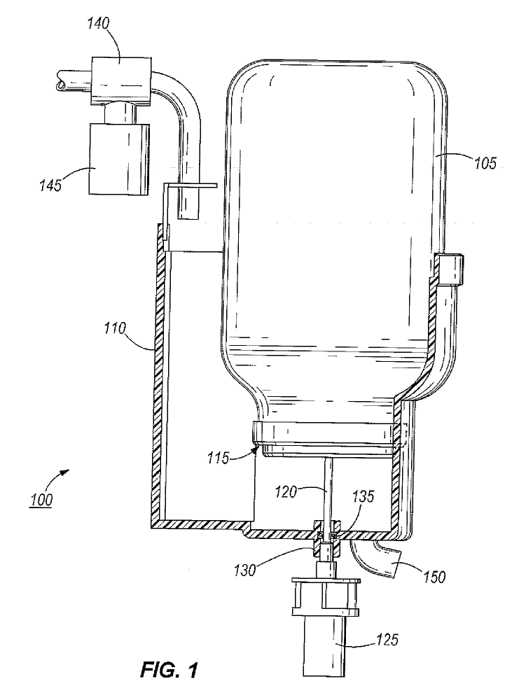

FIG. 1 illustrates an exemplary dispensing system 100. Although this dispensing system will be briefly described below, additional details regarding this dispensing system, as well as other dispensing systems, are disclosed in U.S. patent application Ser. No. 11/404,518, filed Apr. 14, 2006, which is hereby incorporated by reference.

In some embodiments, the dispensing system 100 is configured to dispense or deliver a granulated material or powder (e.g., a chemical such as a detergent, a sanitizer, a rinse aid, bleach, pesticides, pool chemicals, etc.). For example, in some embodiments, a granular or powder material is delivered to a clothes washing machine. In other embodiments, a granular or powder material is delivered to a dish washing machine. In yet other embodiments, the granular or powder material is delivered to devices or areas such as a swimming pool, bucket, other wash system, and the like.

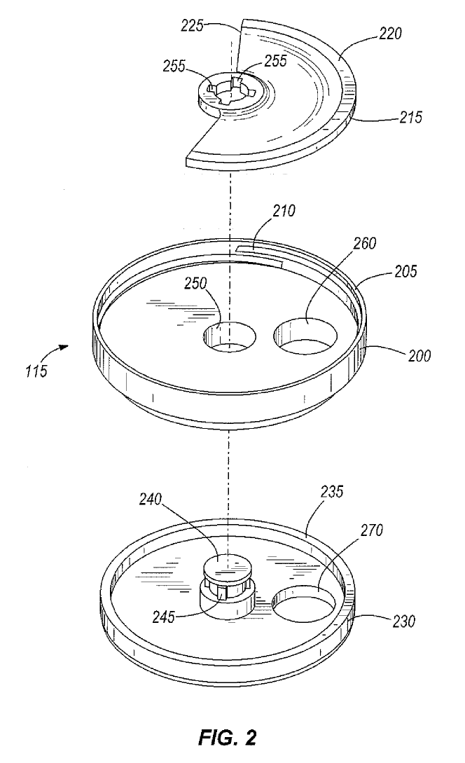

In the embodiment shown in FIG. 1, the dispensing system 100 generally includes a granulated material or powder container 105 that is supported in a dispenser assembly or receptacle 110. The container 105 is closed on one end by a metering and dispensing closure 115, which, as described in greater detail with respect to FIG. 2, can deliver or dose a predetermined amount of material from the container 105 into the receptacle 110. For example, in one embodiment, the dispensing closure 115 is rotated by a drive shaft 120 to deliver the material. The drive shaft 120 is driven by a drive member 125, and is journalled in a collar 130 with a seal 135. Other drive systems can be utilized with this system, such as those disclosed in U.S. patent application Ser. No. 11/404,518.

The dispensing system 100 also includes a water intake conduit 140 that is controlled by a solenoid valve 145. The water intake conduit 140 and solenoid valve 145 are utilized to introduce water into the receptacle 110. For example, in some embodiments, when the solenoid valve 145 is energized, water from the water intake conduit 140 is allowed to enter the receptacle 110. Alternatively, when the solenoid valve 145 is de-energized, water is prevented from entering the receptacle 110. In other embodiments, a valve mechanism other than the solenoid valve 145 may be used.

A water solution outlet conduit 150 is also in communication with the receptacle 110. For example, the outlet conduit 150 allows water to exit the receptacle 110. In some embodiments, as described in greater detail below, water is mixed with dispensed material prior to exiting the receptacle 110 through the outlet conduit 150. In the embodiment shown in FIG. 1, liquid or solution is allowed to exit the receptacle 110 through the outlet conduit 150 relatively unobstructed. In other embodiments, the outlet conduit 150 may include a solenoid valve or other valve, similar to the solenoid 145.

In some embodiments, as described in greater detail below, the dispensing system 100 can also include electronic components such as a controller and one or more conductivity sensors. For example, in one embodiment, one or more conductivity sensors are positioned in the receptacle 110 to monitor the conductivity of the receptacle 110 (and the liquid disposed or flowing therein).

As shown in FIG. 2, the metering and dispensing closure 115 is generally composed of three basic components. For example, the closure 115 generally includes a cap member 200 with an upstanding wall 205 and internal threads 210 for engaging complementary threads on the container 105. The second component is a rotatable disk 215 with a raised peripheral wall 220, as well as a cutaway portion 225. Rotatable disk 215 is configured to be seated inside the cap member 200. The third component is a rotatable disk 230 with a raised peripheral wall 235 and a stub shaft 240 with projections 245. These projections 245 fit through an opening 250 in the cap member 200 in a manner that the projections 245 engage slots 255 in the rotatable disk 215. Rotatable disks 215 and 230 are rotated by the shaft 120 (see FIG. 1) connected to the stub shaft 240. Additional details regarding the closure can be found in U.S. patent Ser. No. 11/404,518, filed Apr. 14, 2006, which is hereby incorporated by reference.

Referring to FIGS. 1 and 2, in operation, the container 105 holding the material is supported in the receptacle 110. Water is introduced into the receptacle 110 through the water intake conduit 140. The metering and dispensing closure 115 is attached to the container 105. When the disks 215 and 230 of the closure 115 are properly aligned, the material from the container 105 is free to enter into a measuring opening or chamber 260 as it is uncovered by disk 215 and cutaway 225 (see FIG. 2). However, the material from the container 105 cannot pass into the receptacle 110, as the passage is blocked by rotatable disk 230. Activation of the drive member 125 and rotation of the drive shaft 120 causes the upper rotatable disk 215 and the lower rotatable disk 230 to move to a second position in which no more material can enter the opening 260, which has become a measuring chamber. Continued rotation of the disks 215 and 230 allows for the opening 260 to be positioned over opening 270, which allows the dose of material from the measuring chamber to flow into the receptacle 110 and be mixed with water from the intake conduit 140. The mixed material then exits the receptacle 110 through the water solution outlet conduit 150. In some embodiments, multiple doses are delivered during a single delivery cycle.

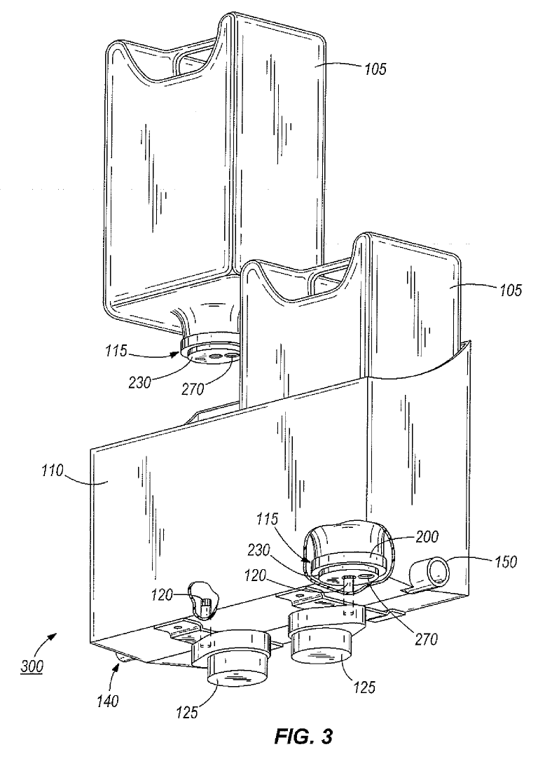

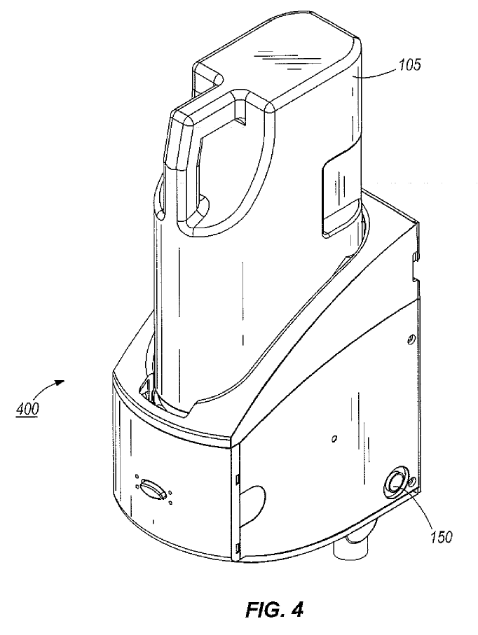

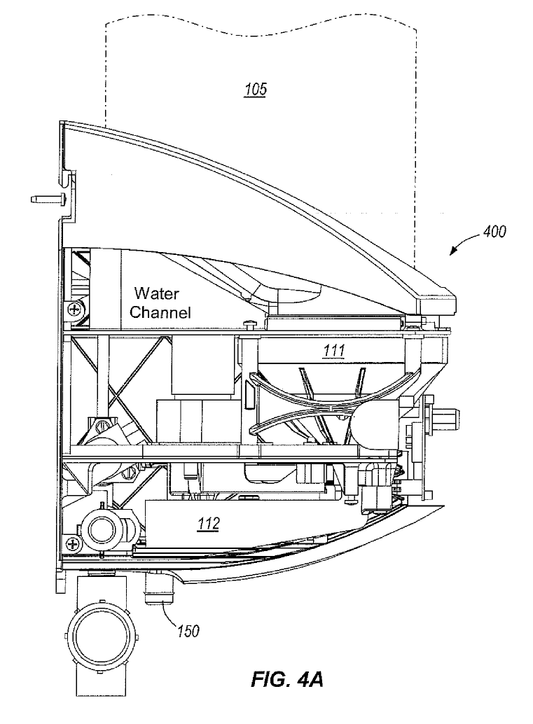

Referring to FIGS. 3 and 4, additional embodiments of dispensing systems are shown. In the embodiments shown in FIGS. 3 and 4, components similar to, or the same as, the components shown in FIGS. 1 and 2 are labeled with like numerals. For example, FIG. 3 illustrates a dispensing system 300 that includes two containers 105. In some embodiments, the separate containers 105 are utilized to introduce separate powder materials (e.g., a sanitizer and a detergent) to the water supply. FIG. 4 illustrates another embodiment of a dispensing system 400 that includes an alternative type of container 105.

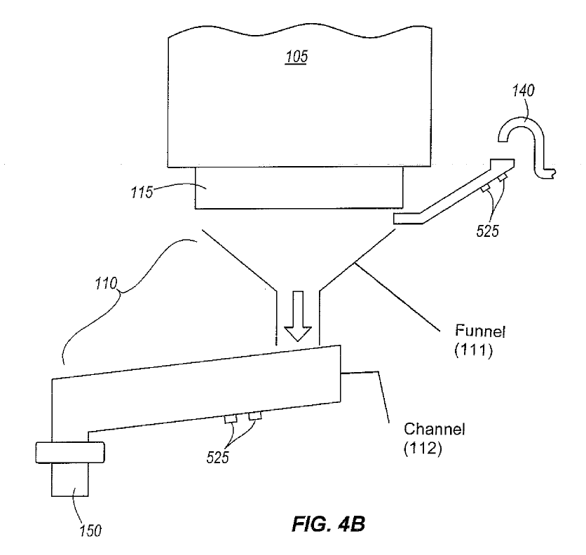

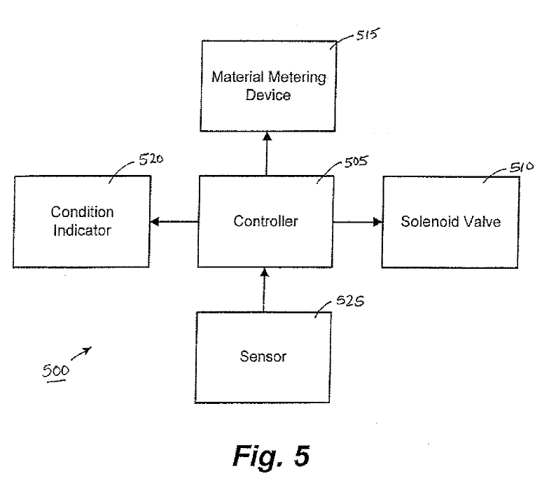

The dispensing systems described with respect to FIGS. 1-4 are provided as exemplary systems only. It should be understood that the control methods described with respect to FIGS. 5-20 may be applied to a variety of dispensing systems. For example, in other embodiments, a dispensing system need not include a receptacle that contains water. An alternative dispensing system may utilize a separate portion that allows a material to be dropped into an additional container having a liquid predisposed therein. Additionally or alternatively, other liquids such as water miscible and immiscible solvents including water and ether could be employed in a dispensing system.

Although FIGS. 1-3 illustrate a receptacle that is configured much like a reservoir or holding tank that is selectively filled and emptied, the receptacle wherein the dispensed chemical and diluent (e.g. water) mix can have alternative configurations. For example, as illustrated in FIGS. 4A and 4B, the dispenser illustrated in FIG. 4 has a conduit or series of conduits 111 and 112 defining the receptacle 110. Specifically, the dispensable materials are dispensed from the container 105 and into a funnel 111. The dispensable materials are flushed from the funnel 111 with water flowing through the funnel 111 from the water inlet 140. When flushed from the funnel 111, the materials flow through an angled channel 112 to an outlet 150 of the dispenser 400. As further illustrated in these figures, sensors 525 are provided adjacent the water inlet and channel 112 to sense the condition of the one or more parameters of the dispenser. Although two sensors are illustrated, more or less sensors can be utilized in practice. Additional details regarding the construction and operation of this type of dispenser is disclosed in U.S. patent application Ser. No. 11/404,518, filed Apr. 14, 2006, which is hereby incorporated by reference.

FIG. 5 is a block diagram of an exemplary control system 500. In some embodiments, the control system 500 can be used, for example, to control the components described with respect to the dispensing systems shown in FIGS. 1-4. In other embodiments, the control system 500 may be applied to an alternative dispensing system. Generally, the control system 500 utilizes a controller 505 to operate a solenoid valve 510, a material metering device 515, and a dispensing system condition indicator 520. Additionally, the controller 505 receives information from one or more sensors 525, such as conductivity sensors. In some embodiments, additional sensors may be employed, as described in greater detail below.

Generally, the controller 505 is a suitable electronic device, such as, for example, a programmable logic controller (“PLC”), a personal computer (“PC”), and/or other industrial/personal computing device. As such, the controller 505 may include both hardware and software components, and is meant to broadly encompass the combination of such components. In some embodiments, the solenoid valve 510 is a normally closed valve that opens when energized. For example, the controller 505 transmits a signal to the solenoid valve 510 to open the solenoid valve 510. The material metering device 515 can be used to control the amount of material that is dispensed from a container. For example, in some embodiments, the metering device 515 is similar to the closure 115 shown in FIGS. 1-4. Similar to the solenoid valve 510, the metering device 515 is controlled via a signal from the controller 505. The condition indicator 520 can include one or more visual and/or audible indicators (e.g., a light, a liquid crystal display (“LCD”) unit, a horn, etc.) to indicate to a user a condition of the dispensing system (e.g., as described with respect to FIG. 20). In some embodiments, the sensors 525 are analog conductivity sensors that transmit a variable signal (e.g., a 0-10 volt signal, a 0-10 milliamp signal, etc.) to the controller 505 that is indicative of the conductivity of the area surrounding the sensors 525.

In operation, generally, the controller 505 utilizes the information from the sensors 525 to determine how to control the solenoid valve 510, the metering device 515, and the dispensing system condition indicator 520. For example, in some embodiments, during a material delivery cycle (e.g., a cycle in which one or more doses of material are dispensed), the controller 505 initially transmits a signal to the solenoid valve 510 to energize the solenoid valve 510. Once energized, the solenoid valve 510 allows water to flow. This initial influx of water can be referred to as a pre-flush. Additionally, the controller 505 receives conductivity information via signals from the sensors 525. For example, in some embodiments, when the material is mixed with water, the solution is substantially more conductive than water alone. Thus, the sensors 525 can measure the conductivity of the water and/or water/material solution, and generate a corresponding signal that is transmitted to the controller 505. The controller 505 utilizes the conductivity information to determine whether to dispense one or more doses of material into the flowing water. If the controller 505 determines not to dispense the material, the controller 505 may generate a dispensing error condition signal that is transmitted to the condition indicator 520, which then indicates the error. After dosing, the controller 505 keeps the solenoid valve 510 energized to allow the flowing water to clear away the delivered material. This water flow after dosing can be referred to as a post-flush. Following and/or during the post-flush, the controller 505 also utilizes the conductivity information from the sensors 525 to verify that the material was properly administered and/or received by downstream components. If the controller 505 determines that the material was not properly administered and/or received by downstream components, the controller 505 may generate a dispensing error condition signal that is transmitted to the condition indicator 520, which then indicates the error.

In some embodiments, the control system 500 may include an input device that allows a user to input and control one or more user changeable settings. For example, a user may use the input device to enter a material amount (e.g., a number of doses to deliver), a length and/or amount of pre-flush, and a length and/or amount of post-flush. In some embodiments, for example, the pre-flush is adjustable between approximately 1.5 and 5 seconds in duration and the post-flush is adjustable between approximately 2 and 10 seconds in duration. Additionally, as described in greater detail below, a user may enter one or more conductivity thresholds, which the controller 505 can use to decide whether to deliver the material.

In some embodiments, the control system 500 may contain more components than those shown in FIG. 5. In one embodiment, the control system 500 includes multiple sensors for measuring conductivity at different locations in a dispensing system. For example, as shown in FIG. 4B, a first sensor can be positioned near an intake conduit for measuring and verifying water flow, while a second sensor can be positioned in a receptacle near an outlet conduit for measuring the conductivity of a water/material solution. Additionally, a downstream sensor can be added to the control system 500 that measures the conductivity of the water/material solution after the solution has exited the receptacle (e.g., in the clothes or dish washing machine). In another embodiment, the control system 500 may include a communication device that allows the control system 500 to communicate with other systems. For example, in some embodiments, the control system 500 can track the amount of material that is available to be dispensed, and transmit a notification signal to another system when the material level is low. The control system 500 may also transmit operational information (e.g., dosage amount, length of pre-flush and post-flush, dispensing system errors, etc.) to one or more other systems (e.g., a central control system). Additionally, the control system 500 may be operated by another system via the communication system.

In some embodiments, the controller 505 may generate a dispensing error condition signal for reasons other than those described above. For example, in embodiments that include more than one sensor 525 (e.g., one sensor 525 positioned proximate to a water intake conduit and one sensor 525 positioned near an outlet conduit), the controller 505 may generate a dispensing error condition signal if the signals from the sensors 525 are not consistent. For example, if the sensor that is proximate to the water intake conduit 525 indicates that water is present, but the sensor 525 that is proximate to the outlet conduit does not indicate that water is present, a dispensing error condition may be identified. In another embodiment, an error condition signal may be generated if a problem with the communication system is identified (e.g., the communication system is unable to transmit information to other systems).

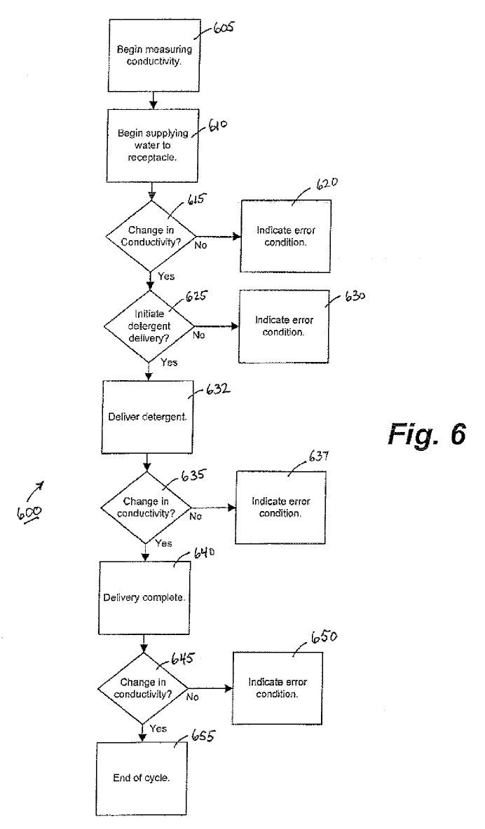

FIG. 6 illustrates a process 600 for controlling the operations of a dispensing system (e.g., the dispensing system 100) using a control system (e.g., the control system 500) during a material delivery cycle. In some embodiments, the process 600 can also be used to verify that a material has been properly delivered, as well as provide an indication of how much material has been delivered. While the process 600 is described as being carried out by the components included in the dispensing system 100 and/or the control system 500, in other embodiments, the process 600 can be applied to other systems.

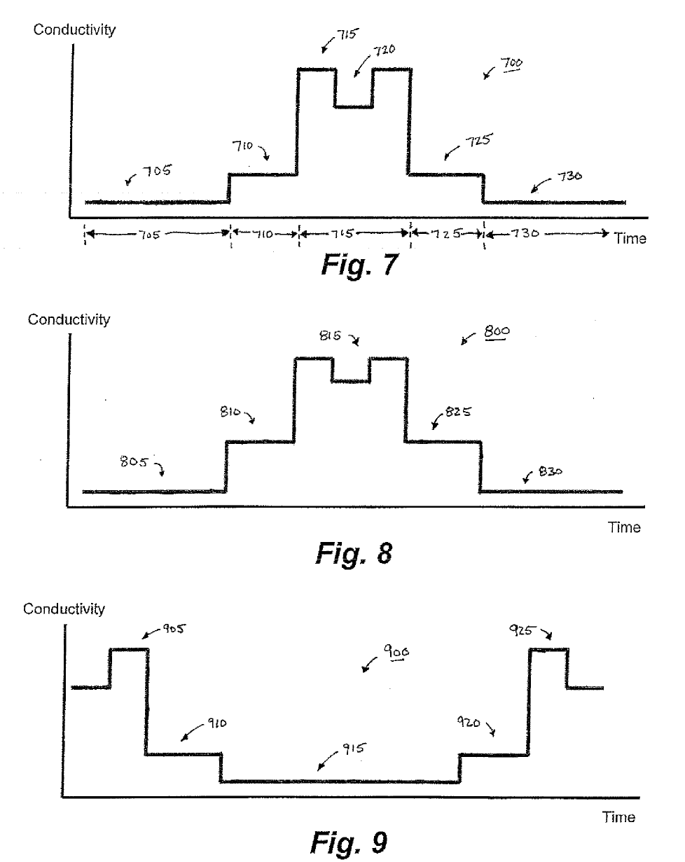

The first step in the process 600 is to begin measuring conductivity in the receptacle 110 (step 605). This can be accomplished, for example, by initializing the conductivity sensor 525. In some embodiments, the conductivity sensor 525 is in constant operation, generating and transmitting signals indicative of conductivity to the controller 505, and does not need to be initialized. Next, water is supplied to the receptacle 110 for a pre-flush operation (step 610), and a change in conductivity is verified (step 615). For example, the controller 505 verifies that the conductivity monitored by the sensor 525 changes when water is added. The controller 505 can verify or determine if conductivity changes are appropriate by comparing the conductivity signal from the sensor 525 to a stored set of conductivity thresholds. With reference to FIG. 6, the conductivity comparisons are described in general terms (e.g., a change in conductivity). However, several specific exemplary plots of conductivity over time are provided with respect to FIGS. 7-19. These plots provide specific examples in which conductivity values are compared with one or more conductivity thresholds to identify whether conductivity values are appropriate.

The comparison of conductivity values to conductivity thresholds can also aid in determining whether a dispensing error condition is present. For example, if the conductivity that is monitored by the sensor 525 does not change in accordance with bounds or thresholds set in the controller 505 pertaining to a material delivery cycle, a dispensing error condition may be indicated (e.g., displayed by the condition indicator 520) (step 620). For example, in some embodiments, the condition indicator 520 can indicate a dispensing error condition using an array of lights (e.g., as described with respect to FIG. 20). In another embodiment, as previously described, the condition indicator 520 can indicate a dispensing error condition using an LCD unit, or similar visual device. Additionally or alternatively, an audible alarm may be used to indicate a dispensing error condition, or a message may be sent. As described in greater detail below, dispensing error conditions may include a “no water” condition, a “blocked dispenser” or a “blocked flow path” condition, and/or an “out of product” condition. Other dispensing error conditions are also possible (e.g., a “drive failure” condition, a “solenoid valve failure” condition, etc.). Furthermore, some conditions can be further refined, such as the “blocked flow path” condition, to indicate whether the condition is caused upstream or downstream from the sensor.

Referring still to FIG. 6, if the conductivity monitored by the sensor 525 changes in accordance with the limits or thresholds set in the controller 505, the controller 505 then determines whether to dispense one or more doses of material (step 625). If the controller 505 determines not to dispense the material, a dispensing error condition may be indicated (step 630). Such a determination may be made, for example, if there is a change in conductivity monitored by the sensor 525, but the change is not consistent with certain conductivity thresholds. If the controller 505 determines to dispense one or more doses of material, such doses are dispensed and the conductivity is measured while dosing (step 632). The next step in the process 600 is to determine if the conductivity monitored by the sensor 525 changes appropriately during and/or after dosing (step 635). If the change in conductivity is not appropriate, or there is no change in conductivity at all, a dispensing error condition may be indicated (step 637). If the conductivity change is appropriate, delivery of the material is completed and a post-flush operation is initiated (step 640), and a final conductivity change is verified (step 645). If the final change in conductivity is not appropriate, or there is no change in conductivity at all, a dispensing error condition may be indicated (step 650). If the change in conductivity is appropriate, the process 600 ends (step 655), and the material delivery cycle is complete. Upon completion, the controller 505 can determine or verify that the material has been properly delivered. The controller 505 can also determine how much material was delivered by determining how many doses were delivered (e.g., see step 632). The process 600 is completed each time a material delivery cycle is initiated.

In other embodiments, an alternative process may be used to deliver the material to the receptacle 110. For example, in some embodiments, conductivity may be verified at additional points during the process. Additionally or alternatively, other parameters may be monitored (e.g., material weight, inductance, turbidity, etc.) and used to determine if one or more doses of material should be delivered and/or if the doses were properly received.

FIGS. 7-19 illustrate exemplary plots of conductivity over time. The plots contain conductivity traces that can be used, for example, to determine a condition of a dispensing system (such as the dispensing system 100) during a material delivery cycle. For example, in one embodiment, the controller 505 can generate conductivity traces similar to those shown in the plots using signals from the sensor 525. The controller 505 can then compare the conductivity values monitored by the sensor 525 to conductivity thresholds in order to determine a condition of the dispenser system 100 and optionally take further action (e.g., alert a user and/or send signals to modify operation of the dispensing system). As should be recognized by one of ordinary skill in the art, the plots in FIGS. 7-19 set forth only several examples of possible conductivity values during a material delivery cycle, and the controller 505 is capable of determining a condition of the dispensing system 100 based on a variety of conductivity values. Generally, as described in greater detail below, in addition to absolute conductivity (e.g., the magnitude of the conductivity signal from the sensor 525), conductivity transitions (e.g., changes in conductivity) can be used to determine a condition of the dispensing system 100.

FIG. 7 illustrates an exemplary plot 700 that represents an ideal receptacle conductivity (as monitored by the sensor 525) during a material delivery cycle when relatively “soft” water is supplied to the receptacle 110 via the intake conduit 140. For example, during an idle period 705, the conductivity of the receptacle 110 is relatively low. This is due to the receptacle 110 being relatively empty or dry and the solenoid 145 being in an “off” position, which prevents water from entering the receptacle 110. During a pre-flush period 710, the solenoid is activated, allowing water into the receptacle 110. As such, the conductivity rises from the idle level, representing the conductivity of the soft water supply. During a dosing or dispensing period 715, the drive 125 is activated, which causes the closure 115 to deliver one or more doses of material from the container 105 into the receptacle 110. As such, the conductivity again rises, representing the conductivity of the water/material solution in the receptacle. A dip or depression 720 may be present during the dosing period 715 due to the rotation of the closure 115 and the interruption of material entering the water. After the delivery of the material has been completed, the solenoid 145 remains activated and water continues to flow through the receptacle. This post-delivery period can be referred to as a post-flush period 725. During the post-flush period 725, the conductivity quickly fails to the level of the pre-flush period 710 as the material is taken away and water remains. After the post-flush period 725 is completed, the solenoid valve 145 is deactivated (i.e., the water supply is shut off ), and the conductivity level falls. During a second idle period 730 the receptacle 110 is once again relatively empty and dry.

FIG. 8 illustrates an exemplary plot 800 that represents an ideal receptacle conductivity during a material delivery cycle when relatively “hard” water is supplied to the receptacle 110 via the intake conduit 140. In some aspects, the plot 800 is similar to the plot 700. For example, the plot 800 includes an idle period 805, a pre-flush period 810, a dosing period 815, a post-flush period 825, and a second idle period 830 during which a chain of events similar to those described with respect to FIG. 7 occurs. However, due to differences in mineral constituents of the water, the conductivity levels during the periods 810-825 may be different. For example, as shown in FIG. 8, the pre-flush period 810 and post-flush period 825 exhibit slightly higher conductivities than those shown in FIG. 7.

FIG. 9 illustrates an exemplary plot 900 that represents an ideal receptacle conductivity during a material delivery cycle, similar to that shown in FIG. 7. However, in the embodiment shown in FIG. 9, material dosing has been interrupted or paused during delivery. For example, the conductivity begins at a level consistent with a dosing period 905, and then falls to a level consistent with a post-flush period 910 and an idle period 915. The conductivity then rises to a level consistent with a pre-flush period 920 and another dosing period 925. In some embodiments, such pausing and resuming can be implemented during a system calibration. For example, in some embodiments, the dispensing system 100 includes a calibration mode that allows for at least a portion of the water and/or water/material solution to be tested with the sensor 525 (or another sensor) prior to being released from the dispensing system 100. During the calibration mode, a calibration chamber may be used to collect the water and/or water/material solution. In order to ensure that the calibration chamber does not overflow, the dosing of material can be paused, allowing the calibration chamber to empty. The dosing can then be resumed once the calibration system has reached equilibrium.

In some embodiments, the pause and resume functions may be used differently. For example, in some embodiments, solution concentration (i.e., the amount of dispensed material per unit of water) is measured downstream from the dispensing system 100 (e.g., in an associated washing machine). If the solution concentration approaches or reaches a material concentration set point (e.g., a concentration set point stored in the controller 505), the dispensing system 100 can be paused while the number of material doses actually delivered is verified. The dispensing system 100 can then be recalibrated accordingly. For example, the system 100 can recalculate the number of doses of material needed to increase the washing machine tank's conductivity by a predetermined amount. Other recalibration schemes are also possible.

In another embodiment, the pause and resume functions may be used while delivering two materials to the receptacle 110 (see FIG. 3). For example, in some embodiments, 0-240 doses of a first material are fed for every dose of another material. Due to power and/or drive component constraints, only one material may be fed at a time. Thus, delivery of the one material may be paused while delivery of the other material is completed.

In yet another embodiment, the pause and resume functions may be used in dispensing systems that do not include a conductivity sensor (or when the conductivity sensor is turned off). In such embodiments, an associated downstream washing machine may send a trigger signal to the dispensing system as a request to deliver the material. If the trigger signal is lost or interrupted during delivery, the material dosing may be paused until the trigger signal is restored.

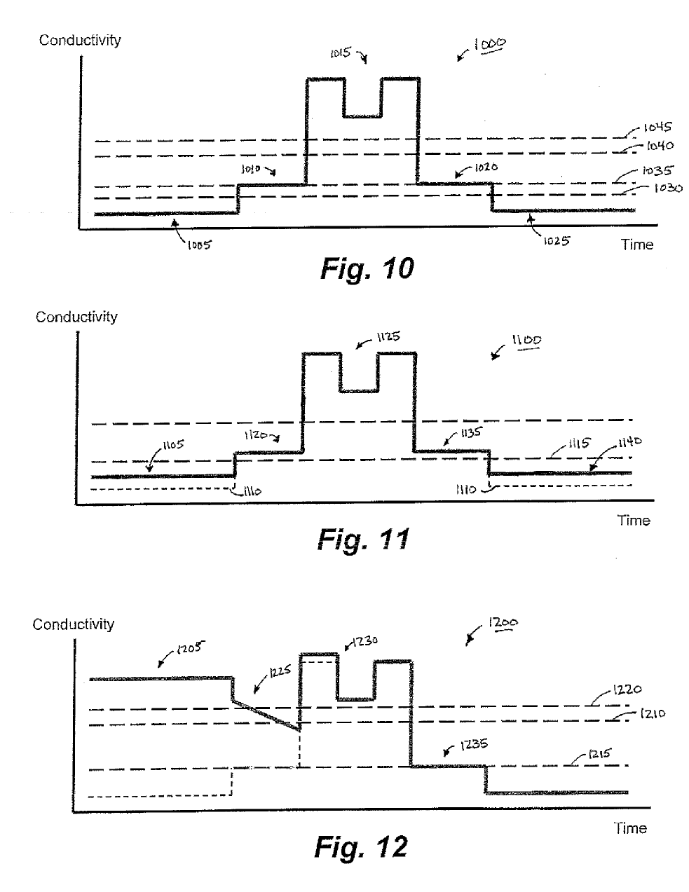

FIG. 10 illustrates an exemplary plot 1000 that represents an ideal receptacle conductivity during a material delivery cycle with multiple conductivity thresholds applied. Similar to the plot 700 shown in FIG. 7, the plot 1000 includes an idle period 1005, a pre-flush period 1010, a dosing period 1015, a post-flush period 1020, and a second idle period 1025. However, the plot 1000 also includes a water conductivity threshold 1030 (e.g., water conductivity relative to the sum of dry conductivity and an offset), a maximum dry conductivity limit 1035, a chemical conductivity threshold 1040 (e.g., chemical conductivity relative to the sum of water conductivity and an offset), and a maximum water conductivity limit 1045.

The water conductivity threshold 1030 is set relative to dry conductivity (e.g., the conductivity of the idle period 1005). Generally, the water conductivity threshold 1030 is set just above the dry conductivity (e.g., an offset from the dry conductivity) to provide a differentiation between a dry receptacle 110 and a receptacle 110 that includes water. For example, the controller 505 can determine that the receptacle 110 contains water if the signal from the sensor 525 breaches the water conductivity threshold 1030. In some embodiments, the water conductivity threshold 1030 is variable, and allows for a user to specify a tolerance range for the sensor 525 to provide accurate detection of the presence or absence of water despite variations in the dry conductivity. For example, for a relatively wide tolerance, the user may choose to set the water conductivity threshold 1030 a relatively greater amount above the dry conductivity. Setting a relatively wide tolerance can allow the controller 505 to determine that the receptacle 110 is substantially empty and dry, even if a small amount of water and/or material is present.

The maximum dry conductivity limit 1035 is set to ensure that the dry conductivity monitored by the sensor 525 is valid. For example, the dry conductivity of the receptacle 110 should be below the maximum dry conductivity limit 1035 for the controller 505 to determine that the dry conductivity value is valid. Generally, the maximum dry conductivity limit 1035 is a fixed limit.

The chemical conductivity threshold 1040 is set relative to the water conductivity (e.g., relative to the conductivity monitored during the pre-flush period 1010 or the post-flush period 1020). Generally, the chemical conductivity threshold 1040 is set at a point above the water conductivity (e.g., an offset from the water conductivity), which provides a differentiation between a receptacle 110 that contains only water and a receptacle 110 that contains water and the material (e.g., a chemical). For example, the controller 505 can determine that the water in the receptacle 110 contains the material if the conductivity signal from the sensor 505 breaches the chemical conductivity threshold 1040 (provided that the solution containing water and the material has a higher conductivity than water alone). In some embodiments, the chemical conductivity threshold 1040 is variable, and is set relative to the water conductivity to allow the controller 505 to accurately detect the presence or absence of material despite relatively wide variations in water conductivity. The chemical conductivity threshold 1040 also allows a user to specify a tolerance range for the sensor 525. For example, for a relatively wide tolerance, the user may choose to set the chemical conductivity threshold 1040 a relatively greater amount above the water conductivity. Setting a relatively wide tolerance can allow the controller 505 to determine that the receptacle 110 contains only water, even if a small amount of material is present.

The maximum water conductivity limit 1045 is set to ensure that the water conductivity monitored by the sensor 525 is valid. For example, the water conductivity of the receptacle 110 should be below the maximum water conductivity limit 1045 for the controller 505 to determine that the water conductivity value is valid. Generally, the maximum water conductivity limit 1045 is a fixed limit.

In other embodiments, more or fewer conductivity thresholds may be set. For example, in one embodiment, the absolute conductivity thresholds are not employed, leaving only the water conductivity threshold 1030 and the chemical conductivity threshold 1040. Alternatively, more conductivity thresholds may be implemented, for example, a maximum chemical conductivity threshold.

FIG. 11 illustrates an exemplary plot 1100 that represents a material delivery cycle in which material residue has adhered to the sensor 525 and has dried. For example, as shown in FIG. 11, the conductivity during a first idle period 1105 is slightly higher than that of an ideal conductivity trace 1110. However, since the conductivity is still below a maximum dry conductivity limit 1115 (e.g., the conductivity of the residue is not great enough to breach the maximum dry conductivity limit 1115), the operation of the dispensing system is unaltered. Accordingly, the conductivity through a pre-flush period 1120, a dosing period 1125, a post-flush period 1135 and a second idle period 1140 is similar to the ideal conductivity shown in FIG. 7. Accordingly, a dispensing error condition is not identified because the conductivity remains within the thresholds throughout the material dispensing cycle. In some embodiments, the water during the post-flush period 1135 is sufficient to clear the residue from the sensor 525. As such, the conductivity during the second idle period 1140 may be lower than the conductivity during the first idle period 1105.

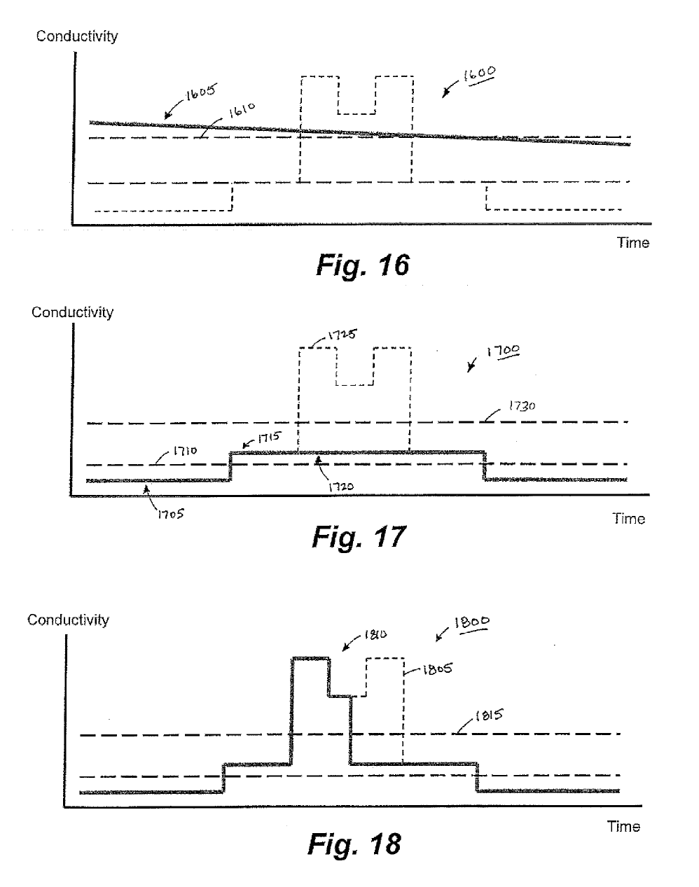

FIG. 12 illustrates an exemplary plot 1200 that represents a material delivery cycle in which material residue has adhered to the sensor 525 and is still wet. For example, as shown in FIG. 12, the conductivity during an idle period 1205 exceeds an absolute or maximum water conductivity limit 1210 (in addition to a maximum dry conductivity limit 1215 and a chemical conductivity threshold 1220). During a pre-flush period 1225, the water clears the sensor 525 of the material residue, and the conductivity begins to fall. After the conductivity has fallen below the maximum water conductivity limit 1210, a dosing period 1230 begins and material is delivered. If the conductivity does not fall below the maximum water conductivity limit 1210, as described in greater detail with respect to FIG. 16, material may not be delivered during the dosing period 1230. Following the dosing period 1230, the water from the post-flush period 1235 clears material residue from the sensor 525, thereby allowing the conductivity to fall. In some embodiments, a dispensing error condition may be initially identified due to the elevated conductivity during the idle period 1205. This dispensing error condition can be indicated using one or more visual and/or audible signals (e.g., a color-coded light of the condition indicator 520). However, as described above, material delivery is still allowed to occur due to the change in conductivity during the pre-flush period 1225. In some embodiments, each error condition that is identified during a material dispensing cycle is also registered or stored in the controller 505 (or another accessible memory location), such that a user can access the stored error conditions. In this way, the user may be able to more easily identify past errors, and use that knowledge to repair or troubleshoot the dispensing system.

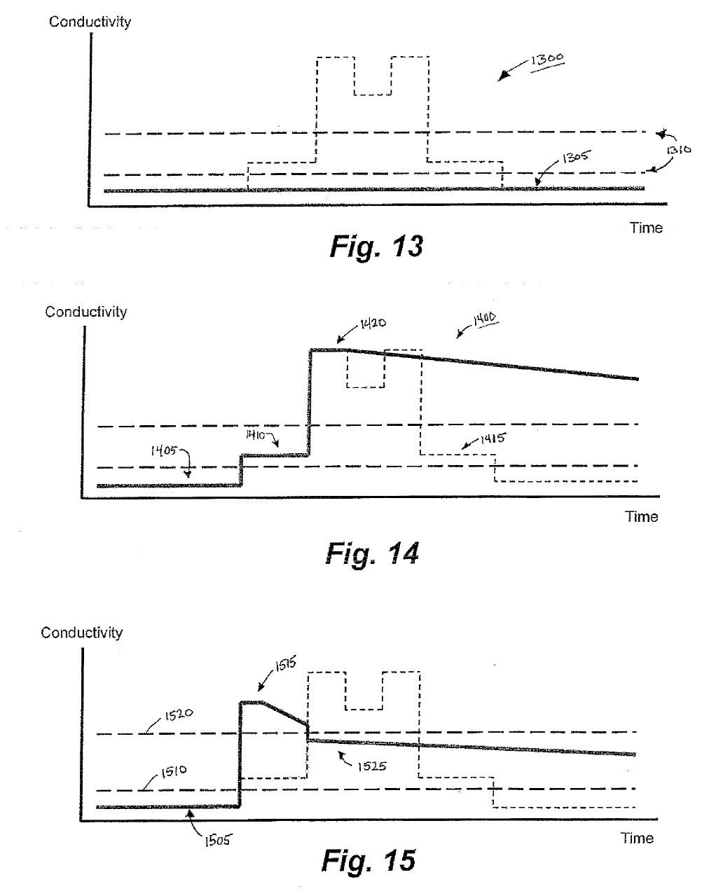

FIG. 13 illustrates an exemplary plot 1300 that represents a material delivery cycle in which the sensor 525 has been disconnected, or the receptacle 110 has been blocked upstream of the sensor 525. For example, as shown in FIG. 13, conductivity trace 1305 is relatively flat and less than conductivity thresholds 1310. As a result, a dispensing error condition is identified, and can be indicated using one or more visual and/or audible signals. In some embodiments, as described with respect to FIG. 20, each identified dispensing error condition is indicated using a distinct visual and/or audible signal, which allows a user to differentiate between error conditions. For example, in the embodiment shown in FIG. 13, a “no water” dispensing error condition is identified and displayed by the condition indicator 520 (e.g., a colored light that corresponds to the “no water” error condition is lit). Accordingly, a user can quickly identify that the sensor 525 is either disconnected and unable to sense conductivity, or that water is not being supplied. As described above, an error condition flag may also be set in the controller 505. In other embodiments, once a dispensing error condition is identified, the controller 505 may transmit signal(s) to modify operation (e.g., deactivate component(s) of the dispensing system).

FIG. 14 illustrates an exemplary plot 1400 that represents a material delivery cycle in which the water supply fails during material delivery. For example, the conductivity during an idle period 1405 and a pre-flush period 1410 approximately follows that of an ideal conductivity trace 1415. However, after a dosing period 1420, the conductivity does not fall in accordance with the ideal conductivity trace 1415. This is because the water supply has been removed, allowing the material that was delivered during the dosing period 1420 to remain in the receptacle 110 and in contact with the sensor 525. In the embodiment shown in FIG. 14, a “blocked flow path” or “block dispenser” dispensing error condition is identified and displayed by the condition indicator 520. In some embodiments, additional dosing will not be performed after this error condition is identified. For example, a user may have to manually clear the blockage and/or acknowledge the error (e.g., by clearing the error flag in the controller) prior to the dispensing system resuming operation.

FIG. 15 illustrates an exemplary plot 1500 that represents a material delivery cycle in which a slurry that includes the dispensed material and water has adhered and dried to a probe of the sensor 525. For example, during an idle period 1505, the conductivity is generally lower than a maximum dry conductivity limit 1510, indicating that the receptacle 110 is generally free of water and material. However, during a pre-flush period 1515, the conductivity rises above an absolute or maximum water conductivity limit 1520 due to rewetting of dried material on the sensor 525. Additionally, in the embodiment shown in FIG. 15, the conductivity does not fall below the maximum water conductivity limit 1520 until after a dosing period 1525 has begun. As a result, a “blocked dispenser” dispensing error condition is identified, and indicated by the condition indicator 520. In some embodiments, upon identifying a “blocked dispenser” error condition, the controller 505 prevents material delivery. As such, the conductivity continues to fall relatively slowly. In some embodiments, the water continues to flow even if the material is not delivered. This water flow can contribute to the declining conductivity, as some of the slurry is removed from the area near the sensor 525. As described with respect to FIG. 14, a user may have to manually clear the slurry and/or acknowledge the error prior to the dispensing system resuming operation.

FIG. 16 illustrates an exemplary plot 1600 that represents a material delivery cycle in which a water supply is unavailable and a slurry has adhered to a probe of the sensor 525. For example, during an idle period 1605, the conductivity is greater than an absolute or maximum water conductivity limit 1610 due to the slurry on the sensor 525. As a result, an error condition may be identified. However, as described with respect to FIG. 12, rather than halt operation, controller 505 attempts to clear the sensor 525 by releasing water during a pre-flush period. In the embodiment shown in FIG. 16, the water supply is unavailable (e.g., water is not being supplied to the intake conduit 140, the solenoid valve 145 has failed, etc.), and, accordingly, the conductivity level remains above the maximum water conductivity limit 1610. As a result, a “blocked dispenser” error condition is identified and indicated by the condition indicator 520. Additionally, the controller 505 prevents a material delivery or dosing from occurring. Again, a user may have to manually clear the slurry and/or resolve the water supply problem before continued operation can occur. Alternatively, if a plurality of sensors are used (such as illustrated in FIG. 4B), a sensor can be used to sense water flow at the inlet and help isolate the problem either as a “no water” condition or a “blocked dispenser/flow path” condition.

FIG. 17 illustrates an exemplary plot 1700 that represents a material delivery cycle in which the material to be dispensed is unavailable (e.g., the supply of material is exhausted). For example, as shown in FIG. 17, during an idle period 1705, the conductivity is below a water conductivity threshold 1710. During a pre-flush period 1715, the conductivity rises to a level consistent with the conductivity of the supply water (e.g., the water from the intake conduit 140). However, during a dosing period 1720, rather than an increase in conductivity similar to that of an ideal conductivity trace 1725, the conductivity remains at approximately the level of the pre-flush period 1715 (the conductivity does not rise above a chemical conductivity threshold 1730). As a result an “out of product” dispensing error condition is identified and indicated by the condition indicator 520. In some embodiments, the controller 505 may attempt to continue with material delivery (e.g., by rotating the closure 115 to dispense a dose) in order to automatically prime the dispensing system 100 for the next material delivery. However, if the “out of product” dispensing error condition is identified during subsequent material delivery cycles, the controller 505 may halt operation, and require a user to manually refill the container 105 with material or replace the container 105.

FIG. 18 illustrates an exemplary plot 1800 that represents a material delivery cycle in which the supply of material has been exhausted in the middle of a powder delivery. As shown in FIG. 18, the conductivity follows that of an ideal conductivity trace 1805 throughout half of the material delivery cycle, but rapidly falls during a dosing period 1810 as the material runs out. As such, the conductivity falls below a chemical conductivity threshold 1815 during the dosing period 1810, and an “out of product” dispensing condition error is identified and indicated by the condition indicator 520. Similar to the embodiment shown in FIG. 17, the controller 505 may attempt to continue with material delivery (e.g., by rotating the closure 115 to dispense another dose) in order to automatically prime the delivery system 100 for the next material delivery. However, if the “out of product” dispensing error condition is identified during subsequent material delivery cycles, the controller 505 may halt operation, and require a user to manually refill the container 105 with material.

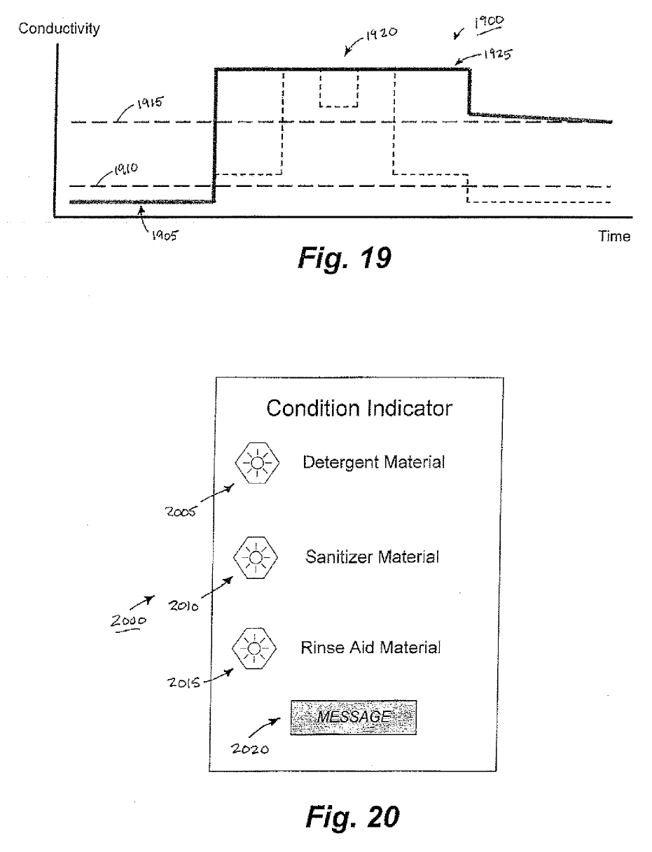

FIG. 19 illustrates an exemplary plot 1900 that represents a material delivery cycle in which the portion of the receptacle 110 leading to the outlet conduit 150 has been blocked with material, but water is still able to seep through the blockage. For example, during an idle period 1905, the conductivity is below a water conductivity threshold 1910. However, during a pre-flush period, the conductivity rises to a point above a maximum water conductivity limit 1915. As a result, a “blocked dispenser” dispensing error condition is identified and indicated by the condition indicator 520. Due to the “blocked dispenser” dispensing error condition, no material delivery is attempted, but the water continues to be supplied. Accordingly, the conductivity remains approximately constant throughout a dosing period 1920 and a post-flush period 1925. After the water supply has been removed, the conductivity falls, but remains above the maximum water conductivity limit 1915. A user may have to manually clear the blockage and/or acknowledge the error prior to the dispensing system resuming operation. In some embodiments, however, the material delivery cycle will be repeated in an attempt to clear the blockage. In such embodiments, water may be supplied during the pre-flush period for a certain number of material delivery cycles (e.g., three delivery cycles). To avoid an overflow condition, however, in some embodiments, water will no longer be supplied during the pre-flush period after three failed material delivery cycles. As such, a user may have to manually clear the blockage and/or acknowledge the error prior to the dispensing system resuming operation.

FIG. 20 illustrates an exemplary embodiment of a condition indicator 2000 for a dispensing system, such as the dispensing system 100, that includes three materials (e.g., a detergent material, a sanitizer material, and a rinse aid material). In other embodiment, the condition indicator 2000 may be adapted to a system that includes more or fewer materials than those shown in FIG. 20. The condition indicator 2000 generally includes a detergent material indicator light element 2005, a sanitizer material indicator light element 2010, and a rinse aid material indicator light element 2015 that correspond to the three materials. Additionally, in some embodiments, the condition indicator 2000 includes a message display (e.g., an LCD or similar type of display). In other embodiments, the condition indicator 2000 can include more or fewer lights (or other indicating components) than those shown in FIG. 20. For example, in some embodiments, the condition indicator may include additional light elements (e.g., a plurality of different colored light elements). Alternatively, the condition indicator may include fewer light elements (e.g., a single light element that changes color).

Generally, the light elements 2005-2015 can be used to indicate a condition of the dispensing system and/or a status of each material. For example, in one embodiment, as described in greater detail below, the light elements 2005-2015 change color according to the condition of the dispensing system. For example, a green light can indicate that the dispensing system is operating properly. However, if an error condition is identified, the light may change color to indicate to a user that an error condition is present.

For example, in one embodiment, after an error condition has been identified (e.g., a “blocked receptacle” condition), a yellow flashing light is used to indicate that the material dispensing system has been disabled (i.e., material will not be dispensed during a dosing period). In order to clear the error condition and continue with dispensing system operation, power to the dispensing system 100 may have to be removed and then restored. In other embodiments, the error condition may be cleared using another method, for example, with an input device located on the face of the condition indicator (e.g., a “clear fault” pushbutton).

In some embodiments, the dispensing system is not disabled until after a certain number of errors or faults have been identified, or after a predetermined time period has elapsed. For example, a controller can register and/or store identified error conditions as they are identified, and disable the dispensing system after three consecutive error conditions. Such embodiments can minimize disabling of the dispensing system due to faulty identified error conditions.

Various features of the invention are set forth in the following claims.

What is claimed is:

1. A method of operating a dispensing system having a material delivery cycle, wherein the material delivery cycle includes supplying water to a receptacle at least partially contained within the dispensing system, performing an operation intended to release a material into the water, and delivering the material to a downstream component, the method comprising:
initiating the material delivery cycle;
monitoring a conductivity proximate to the receptacle; and
identifying one or more error conditions during the material delivery cycle based at least partially on the monitored conductivity.

2. The method of claim 1, further comprising delivering the material to a washing machine that is positioned downstream of the dispensing system.

3. The method of claim 1, further comprising releasing a powder material or a granulated material into the water during the material delivery cycle.

4. The method of claim 1, further comprising operating a material metering device to release one or more doses of material into the water during the material delivery cycle.

5. The method of claim 1, wherein identifying the one or more error conditions includes comparing the monitored conductivity to one or more stored thresholds.

6. The method of claim 5, wherein comparing the monitored conductivity to one or more stored thresholds includes comparing the conductivity to a first threshold and a second threshold, the first threshold corresponding to the sum of a conductivity of the receptacle when the receptacle is relatively dry and a first offset value, the second threshold corresponding to the sum of a conductivity of the receptacle when the receptacle includes water and a second offset value.

7. The method of claim 6, further comprising identifying a blocked receptacle error condition during a first portion of the material delivery cycle if the monitored conductivity is greater than the second threshold.

8. The method of claim 6, further comprising identifying a blocked receptacle error condition prior to the operation intended to release the material being performed during the material delivery cycle if the monitored conductivity is greater than the second threshold.

9. The method of claim 6, further comprising identifying a no water error condition during the material delivery cycle if the monitored conductivity is not greater than the first conductivity.

10. The method of claim 6, further comprising identifying an out of material condition while the operation intended to release the material is being performed during the material delivery cycle if the monitored conductivity is not greater than the second threshold.

11. A dispensing system for delivering a material to a receiving component positioned downstream of the dispensing system, the dispensing system comprising:
a receptacle;
a valve configured to control a supply of water to the receptacle, the valve having an off position that prevents water from entering the receptacle and an on position that allows water to enter the receptacle;
a material metering device configured to dispense a material into the receptacle;
a sensor positioned proximate to the receptacle and configured to generate a first signal indicative of conductivity; and
a controller configured to receive the first signal from the sensor and to generate a valve control signal and a material metering device control signal, the valve control signal operable to toggle the valve between the on position and the off position, the material metering device control signal operable to initiate a dispensing of the material, the valve control signal and the material metering device signal being generated at least partially in response to a comparison by the controller of the first signal to one or more stored conductivity threshold values.

12. The dispensing system of claim 11, further comprising a condition indicator, wherein the condition indicator is configured to be in communication with the controller, and to indicate a delivery condition of the dispensing system.

13. The dispensing system of claim 12, wherein the condition indicator includes at least one of a visual indicator and an audible indicator.

14. The dispensing system of claim 11, wherein the controller is configured to store at least a first conductivity threshold value and a second conductivity threshold value.

15. The dispensing system of claim 11, wherein the controller is configured to communicate with one or more other monitoring or control systems.

16. A method of operating a dispensing system, the method comprising:
initiating a material delivery cycle having a pre-flush period, a material dosing period, and a post-flush period;
monitoring a first conductivity during the pre-flush period;
comparing the first conductivity to one or more thresholds, wherein the comparison is used to determine whether to initiate a material delivery during the material dosing period;
monitoring a second conductivity during the dosing period;
comparing the second conductivity to the one or more thresholds, wherein the comparison is used to determine whether material has been dispensed during the material dosing period;
monitoring a third conductivity during a post-flush period; and
comparing the third conductivity to the one or more thresholds, wherein the comparison is used to verify that the material delivered during the dosing period has been delivered to a receiving component positioned downstream of the dispensing system.

17. The method of claim 16, further comprising providing a dispensing system condition indicator, the dispensing system condition indicator operable to generate one or more error condition indications based on the comparison of the first conductivity, the second conductivity, and the third conductivity to the one or more thresholds.

18. The method of claim 17, further comprising generating an error condition indication after the pre-flush period if the first conductivity exceeds a maximum dry conductivity limit.

19. The method of claim 17, further comprising generating an error condition indication after the pre-flush period if the first conductivity does not exceed a water conductivity threshold.

20. The method of claim 17, further comprising stopping the material delivery cycle upon the one or more error condition indications being generated.
